(19) United States
(12) Patent Application Publication
(10) Pub. No.: US 2012/0263847 A1
(43) Pub. Date: Oct. 18, 2012

(54) AUTOMATIC DISTRIBUTOR APPARATUS FOR HEATED FOOD PRODUCTS, SUCH AS PIZZAS OR OTHER PRODUCTS, AND AN OPERATING METHOD

(75) Inventors: Berardo Poli, Scandiano (Reggio Emilia) (IT); Silvio Rocchelli, Scandiano (Reggio Emilia) (IT); Mauro Righi, Rubiera (IT)

(73) Assignee: CIERRECI S.R.L., Reggio Emilia (IT)

(21) Appl. No.: 13/501,268

(22) PCT Filed: Oct. 12, 2010
(86) PCT No.: PCT/IB2010/002623

§ 371 Date: Jun. 26, 2012

(30) Foreign Application Priority Data
Oct. 16, 2009 (IT) RE2009A000101

(51) Int. Cl. A47J 37/04; A23L 1/01

(52) U.S. Cl. 426/520; 99/443 R

(57) ABSTRACT

An apparatus includes a chamber containing a plurality of food products, and a second chamber having a heater. In use, the apparatus: transfers the products individually from the collection chamber to the second chamber; displacing a lower heating device into an inactive position enabling nearing and distancing movement of the product with respect to the upper heating device; vertically translates the product, along a vertical axis, up to a heating position, defined in proximity of and below the active heating surface of the upper heating device; brings the lower heating device into an active position, facing upwards and located below the active surface of the upper heating device. The product interposed, and the upper heating device and the lower heating device heat the product, displacing the lower heating device into the inactive position, vertically translating the product, moving the product to a position outside the second chamber.

### TECHNICAL FIELD

The invention concerns an automatic distributor apparatus for food products, such as pizzas or other products, such as “focaccia” bread and objects which are relatively compact and sufficiently solid, or which are not compact but are arranged on a rigid support.

### BACKGROUND ART

Automatic distributor apparatus for selling hot pizzas are known: they are capable of delivering a pizza, which has been selected—subsequent to the insertion of coins—via a suitable control panel, and exhibit at least one collection chamber capable of containing a plurality of pizzas designed to undergo a final heating process, and a heating chamber for heating the pizzas.

In greater detail, known automatic distributors exhibit a refrigeration unit for storing a number of pizzas enclosed within suitable containers, and an oven for baking the pizzas. The containers are extracted mechanically from the refrigeration unit by a handling group. A cutting group then opens the containers and extracts the pizzas from the containers. The pizzas are subsequently conveyed to the oven for baking. Then the pizzas are transferred to a tray store, where they are placed on respective trays and delivered, arranged on the delivery tray, to the customer outside the distributor.

Known apparatus of this type are however extremely complex, bulky and expensive.

Further, a dispensing cycle lasts a relatively long period of time.

Finally, machines of this sort require the use of a relatively large amount of packaging materials.

An example of this type of apparatus is illustrated in patent documents US 2006/0196883 A1 and WO 03/077213 A1. The illustrated apparatus exhibit a relevant complication due to the relatively complex and/or delicate movements to which the pizza is subjected, in particular for introducing it into a baking oven; this in particular leads to a relatively long time for completing the treatment cycle of the pizza from the moment when the user requests it up to the moment it is dispensed externally of the apparatus.

### DISCLOSURE OF THE INVENTION

An aim of the present invention is to provide an automatic distributor which, while being particularly suitable for handling pizzas, and also other food products having physical characteristics similar to those of pizzas or which are supported by rigid supports (plates and the like), also obviates the abovementioned drawbacks.

In particular, an aim of the invention is to provide a constructionally simple distributor with a limited bulk, which is relatively cheap to manufacture and delivers high performance, especially with regard to operational rapidity.

This and other aims are achieved by the invention as described in the claims herein below.

In the invention, the time required for completing a product treatment cycle (the time between the collection of the product from the first chamber up to the dispensing to the outside of the apparatus) is relatively very brief, thanks to the simplicity of the movements (only translation movements in a vertical axis) to which the product is subjected in the second chamber for its insertion between an upper heating device and a lower heating device, with both elements working contemporaneously on the product.

Also during the stage of transfer of the product important advantages are provided in relation to the operating time and the simplicity of the movements, both of the product and the operating organs.

Further, the simplicity of movements of the organs leads to less constructional complexity and greater functioning reliability.

### BRIEF DESCRIPTION OF DRAWINGS

The invention is described in detail in the following, with the aid of the appended figures of the drawings which illustrates a non-exclusive embodiment thereof, provided by way of a non-limiting example.

FIG. 1 is a front vertical elevation view of the distributor apparatus of the invention, in which the front vertical panelling has been removed to expose the internal chambers of the apparatus.

FIG. 2 is an enlarged detail of FIG. 1, showing the phase when the food product passes from the collection chamber to the second chamber.

FIG. 2A is a detail of FIG. 2 showing a subsequent phase, in which the food product is brought to the heating position.

FIG. 2B shows the same detail as FIG. 2A, highlighting a subsequent phase, in which the lower heating device is brought to a position which is suitable for heating the food product.

FIG. 3 is an enlarged section along the plane III-III of FIG. 1, in which the food product is brought to the heating position.

FIG. 3A is the same section shown in FIG. 3, showing a subsequent phase.

FIG. 3B is the same section shown in FIG. 3A, showing a subsequent phase, in which the lower heating device has been brought into a suitable position for heating the food product.

FIG. 4 is a section view along the plane IV-IV of FIG. 3.

FIG. 5A is a section view along the same plane as FIG. 3, which, besides the upper heating device, shows the zone in which the heated food product is delivered externally of the distributor apparatus.

FIG. 6 is a perspective view of the pack bearing a pizza, the pack being configured as a tray.

FIG. 7 is a perspective view of the pack of FIG. 6, configured as a box enclosing the pizza.

### BEST MODE FOR CARRYING OUT THE INVENTION

The invention is advantageously capable of handling both pizzas and other food products. However, in the description herein below of an embodiment, reference is made to pizzas as an example of application solely for simplicity of description.

The distributor apparatus of the invention comprises at least one collection chamber 10 for containing a plurality of pizzas 11 (or other food products) which are designed to undergo a final heating process.

The pizzas 11 are preferably arranged in the collection chamber, resting on respective rigid or semi-rigid packs-trays 15, the upper surface of which remains open when they are inside the distributor apparatus, the packs-trays 15 being tray-shaped.

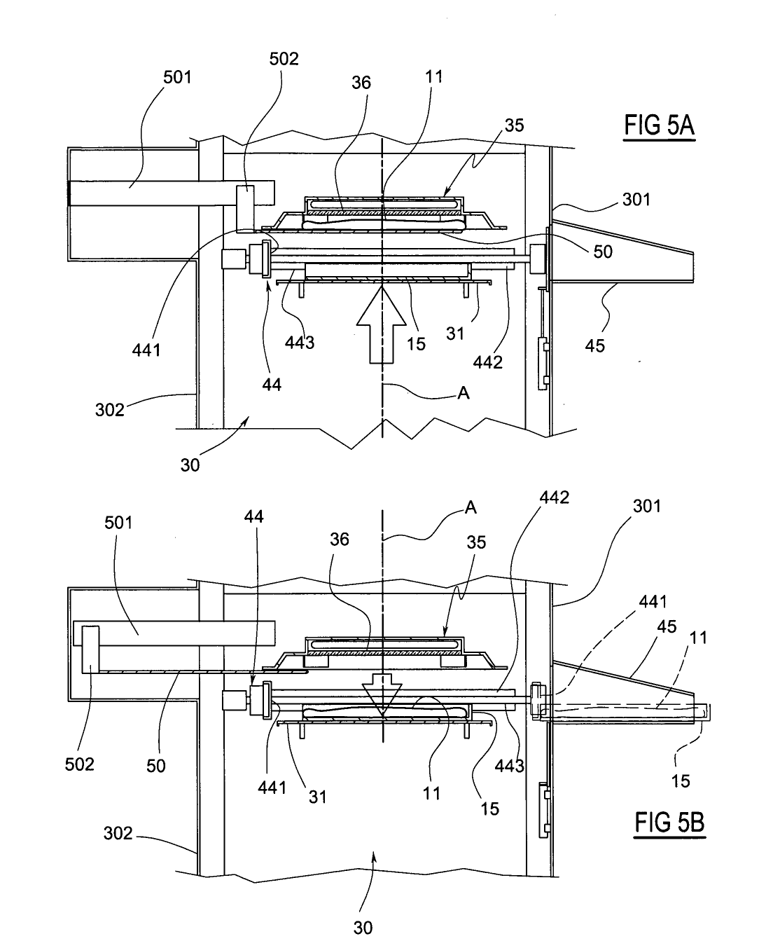

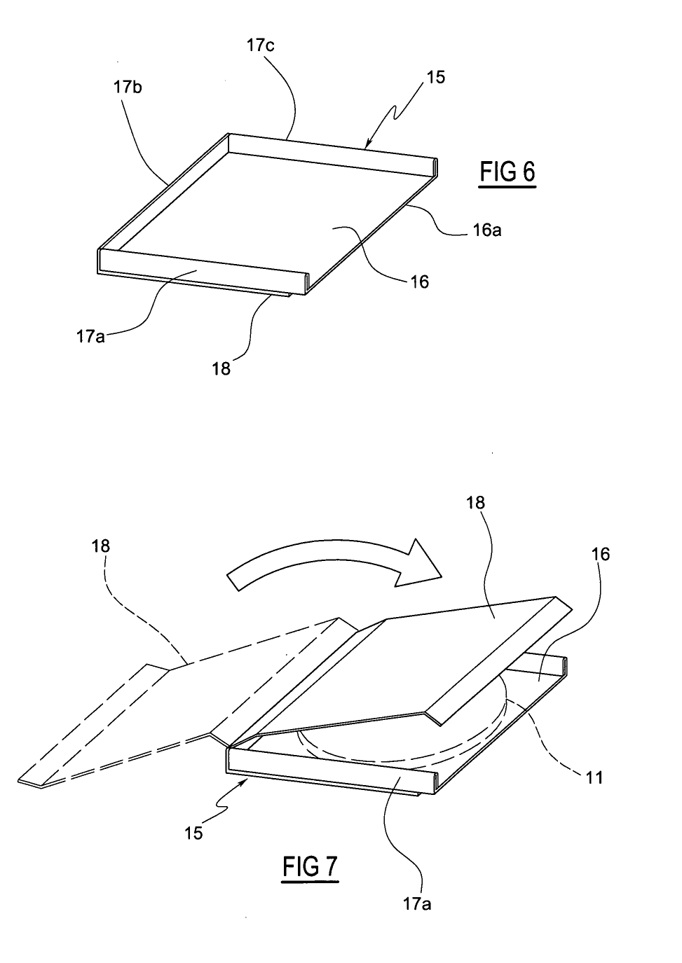

An example of a pack made from sufficiently rigid cardboard is shown in FIGS. 6 and 7. The pack 15 exhibits a horizontal lower base 16 with a broad surface (substantially square in the case of pizzas) which receives the pizza. Three consecutive, vertical side walls 17a, 17b and 17c are joined to the base 16: the walls 17a, 17b and 17c are relatively low (since the pizza 11 is relatively thin) and on three sides they enclose the space around the pizza 11 which is placed in the pack. A portion 18 of cardboard is joined in a single piece to the upper edge of the intermediate wall 17b, folded inferiorly, and arranged so as to adhere to the lower surface of the lower base 16. While the pizza is inside the distributor apparatus, the pack 15 maintains the form described herein above and shown in FIG. 6, functioning as a tray. However, after the pizza has been heated and delivered to the customer outside, the portion 18 can be rotated manually by the customer above the open space containing the pizza, in such a way as to define an upper lid which closes the cardboard pack and at least partially thermally insulates the pizza from the external environment.

The distributor apparatus further comprises a second chamber 30, which exhibits means for heating food products.

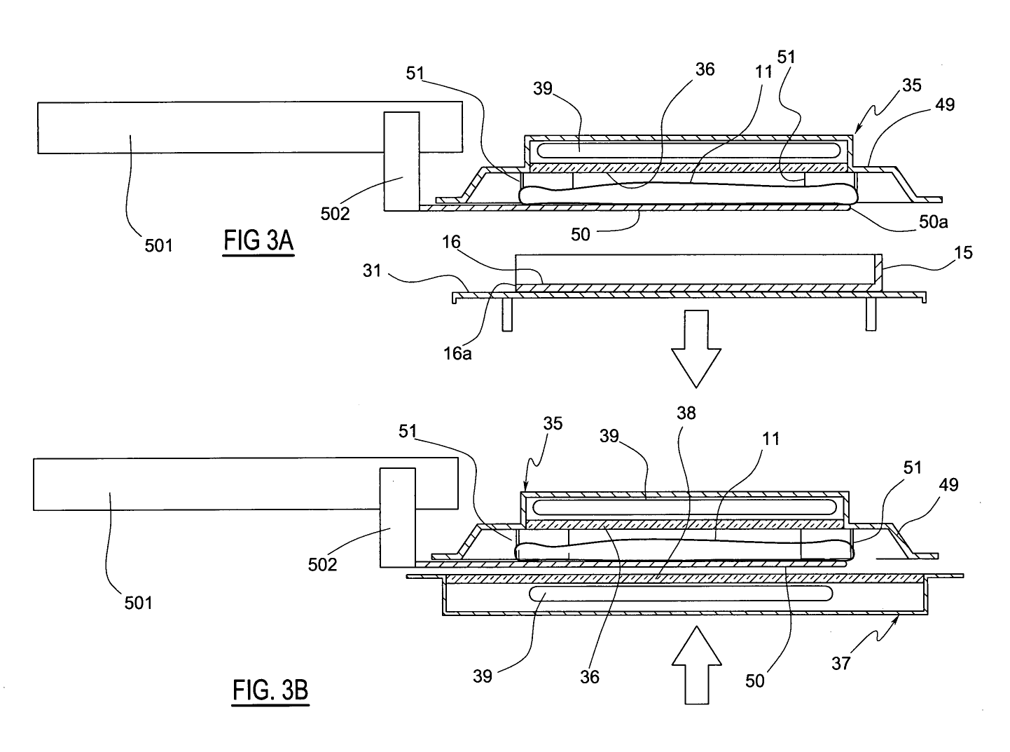

The two chambers 10 and 30 are enclosed by appropriate side and front walls and by upper and lower bases. In FIGS. 5A and 5B, reference numeral 301 indicates the forward vertical wall and reference numeral 302 indicates the rear vertical wall of the chamber 30. The collection chamber 10 also exhibits similar, substantially coplanar walls.

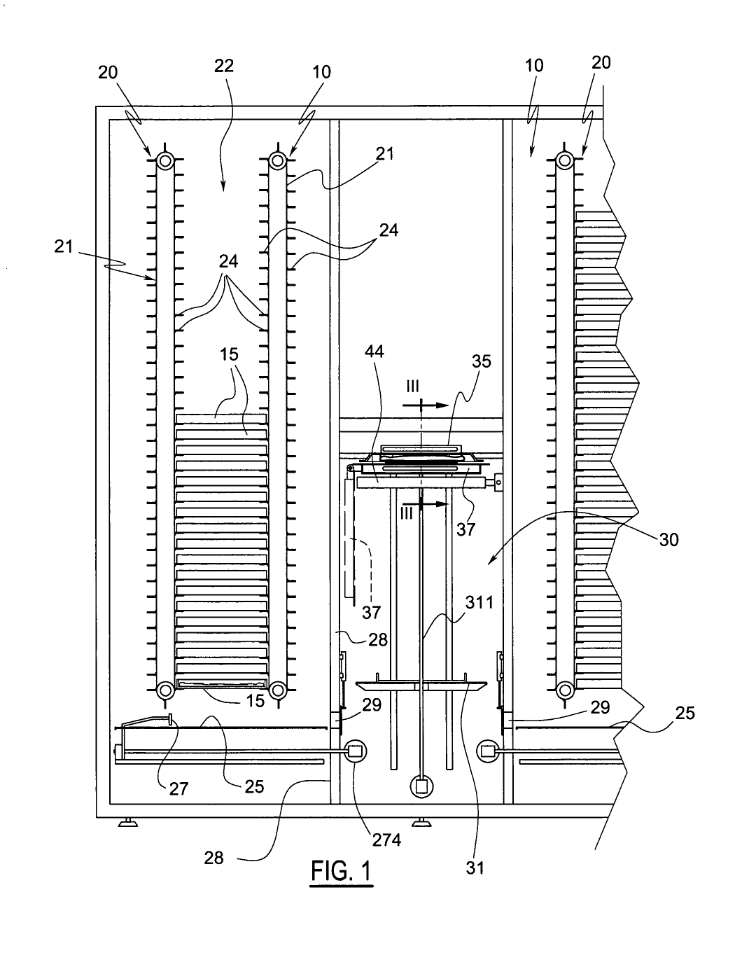

In a preferred (but not exclusive) embodiment, the collection chamber 10 comprises at least a store 20 which collects a plurality of food products 11, the food products 11 being arranged in a vertical column and situated at a distance from one another. In particular, as shown in FIG. 1, the store 20 comprises two vertically-extending belt transporters 21 with two vertical operational surfaces, which surfaces face each other and are positioned opposite each other, thus delimiting a vertical corridor 22. Two series of horizontal shelves 24 are arranged on the two oppositely-positioned surfaces, the shelves 24 in pairs defining a horizontal support surface for packs/trays 15 bearing pizzas.

In use, the corridor 22 contains a plurality of packs/trays 15 with respective pizzas resting on the pairs of shelves 24. In each operational cycle of the distributor apparatus, the two belt devices 21 descend by one step and consequently the pack/tray 15 with a pizza 11 arranged in the bottom position is released by the respective pair of shelves 24, which move away from each other, onto a fixed horizontal lower base 25 which is situated below the bottom end of the corridor 22.

Advantageously, the collection chamber can be refrigerated to aid preservation of the objects 11 collected within it.

The second chamber 30 is arranged adjacent to the collection chamber 10. A side wall 28 preferably separates the two chambers 10 and 30, and an opening is 29 is afforded in the wall 28, at the same level as the lower base 25, to allow the passage of a food product 11 on the respective pack/tray 15, from the chamber 10 to the chamber 30.

In the invention, a support plate 31 is provided for the food products 11, the plate 31 being situated in the second chamber 30, and means are provided to transfer one food product 11 at a time from the collection chamber 10 to the support plate 31.

In particular, a pusher 27 is provided, which is driven in a transverse horizontal direction by drive means, thus pushing one pack/tray 15 with respective pizza 11 at a time—the pack/tray 15 with respective pizza 11 being arranged on the lower base 25—in such a way as to make the pack/tray 15 advance through the opening 29 while resting on the support plate 31, which is arranged in its lower position, at the same level as the lower base 25.

One or more collection chambers 10 can be provided, operating with a single second chamber 30.

For example, two collection chambers 10 can be provided, being arranged to the right and the left of the second chamber 30, with both vertical separating walls 28 affording a respective passage hole 29.

Further, each collection chamber 10 can be provided with more than one store 20, side by side on a same plane. In this case, a single fixed lower base 25 can be provided which is shared by all the corridors 22, a single pusher element 27 being provided to transfer the food product, which is deposited on the base 25, onto the support plate 31.

In the second chamber 30, means are provided for heating the food product, the means comprising an upper heating device 35, which exhibits a downwardly-facing active heating surface 36, and at least one lower heating device 37, which exhibits an upwardly-facing active heating surface 38 (facing upwards to during the baking stage of the food product).

Preferably, the two heating devices 35 and 37 use short-wave infrared heat sources 39 exhibiting a substantially flat form, the respective (transparent) active surface 36, 38 of which emits sufficient heat to heat the food product effectively within a time of one, or very few minutes.

The lower heating device 37 is mobile and is moved between an active position, in which its active surface 38 faces upwardly, and is close to and below the active surface 36 of the upper heating device 35, the food product 11 being interposed between the two active surfaces 36 and 36 in a heating position, and an idle position, in which it does not get in the way of the food product 11 moving closer to, or further from the upper heating device 35.

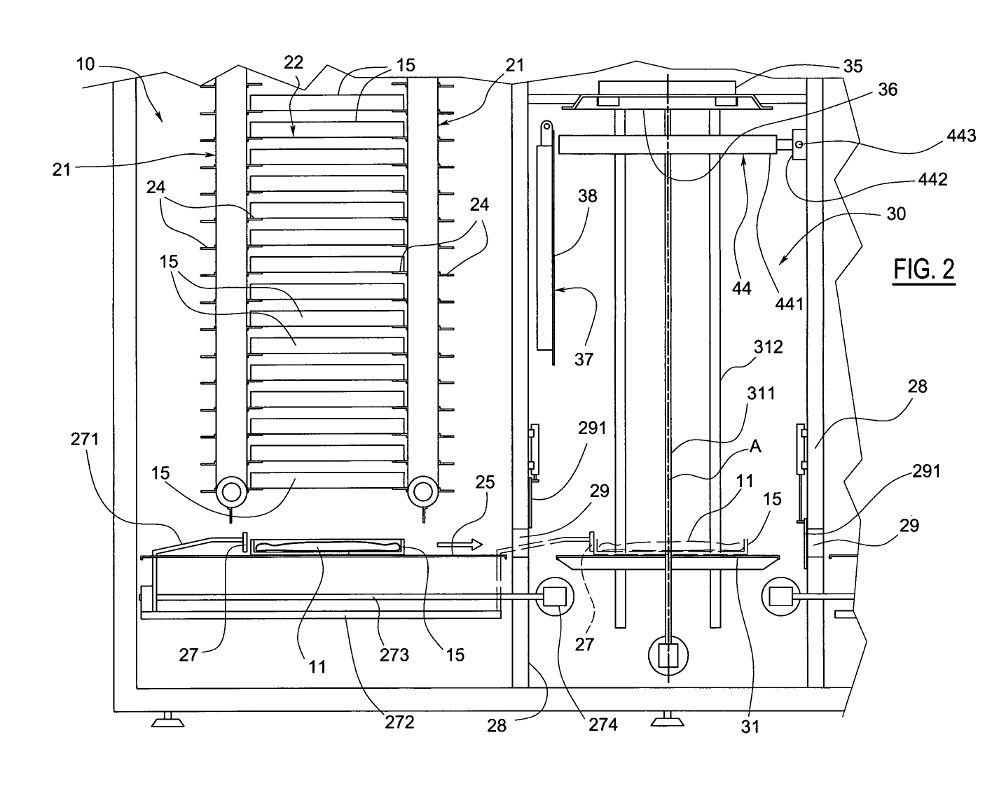

In a preferred (but not exclusive) embodiment, the lower heating device 37 exhibits a support frame 41 which is hinged to the side wall 28 of the chamber in such a way as to define a horizontal axis of rotation situated at a distance from the active surface 38. By rotating approximately 90 degrees, the active surface 38 passes from the inactive position, in which it is arranged vertically and adjacent to the wall 28, to the active position, in which it is arranged horizontally, close to the active surface 36 of the upper device (see FIGS. 2A and 2B).

A blade 50 arranged in the second chamber 30 receives the food product 11 from the support plate 31, and supports the food product 11 in the heating position, close to and below the active surface 36 of the upper heating device 35.

If the food product 11 is situated on a pack/tray 15 (as in the figures), movement means are provided to separate the food product 11 from the respective pack/tray 15, to hold only the food product 11 between the two heating devices 35 and 37 during the heating phase, and then to return the heated food product 11 to the respective pack/tray 15.

In a preferred embodiment, the movement means comprise the support plate 31, which is driven by actuator means (for example a screw and nut screw) which vertically translate the support plate 31 only along a vertical axis A, the translating motion being such as to bring the plate and the food product located on it, starting from a lower position, where it receives a food product 11 which has been transferred from the collection chamber 10 and enters the second chamber 30, into an upper position, where the food product 11 is in the heating position, below close to the active surface 36 of the upper heating device 35. The food product 11 is then vertically translated downwards, into a position where the means for dispensing the heated food product 11 externally are located.

The movement means further comprise the blade means 50, and actuator organs which move the blade 50, inserting the blade 50 between the upper surface of the pack/tray and the lower surface of the food product 11, which rests upon the pack/tray when the support plate is in the upper position.

The method of the invention concerns the method for moving and heating the food products (in particular pizzas) 11, which method is implemented by the automatic distributor apparatus, and includes, for each food product: transferring the food products 11 singly from the collection chamber 10 to the second chamber 30;

displacing the lower heating device 37 into an inactive position in which the nearing and distancing movement of the food product 11 with respect to the upper heating device 35 is enabled;

vertically translating the food product, moving the food product along a sole vertically-transferring axis A, starting from entry thereof into the second chamber 30, up to a heating position, defined in proximity of and below the active heating surface 36 of the upper heating device 35, where the active surface is facing downwards;

then bringing the lower heating device 37 into an active position in which its active surface 38 faces upwardly and is arranged below the active surface 36 of the upper heating device 35, the food product being interposed;

the upper heating device and the lower heating device performing the heating of the food product,

newly displacing the lower heating device (37) into the inactive position, vertically translating the food product (11), moving the food product downwards along the vertical transferring axis (A) up to an expelling position outside the second chamber (30).

In a preferred (but not exclusive) embodiment of the method, as shown in the figures, each store 20 of the collection chambers 10 is initially filled with pizzas (or other food products) which are arranged on respective rigid or semi-rigid packaging packs/trays 15, the upper surface of which is open.

The pizzas 11 are advantageously pre-cooked, and a temperature of approximately 0-5° C. is maintained in the chambers 10. This ensures relatively prolonged (several days) conservation of the product. Further, thanks to the relatively low temperature, the product is maintained in a relatively rigid condition, such as to facilitate its manipulation up to the baking stage.

A pizza movement cycle commences when an electronic management and movement system (of a known type and not shown in the figures) is started, typically by inserting coins. The first phase consists of transferring each food product from the collection chamber 10 to the second chamber 30, together with the respective pack/tray 15. This is achieved by advancing the two vertical transporters 21 downwardly by one step, in such a way that the pack/tray 15, with the pizza 11, descends to rest on the lower base 25, beneath and at a distance from the belt transporters 21 (as shown by a continuous line in FIG. 2). Then the pack/tray is transferred by the pusher 27 into the second chamber 30 and onto the plate 31, passing through the opening 29 (as shown by a broken line in FIG. 2).

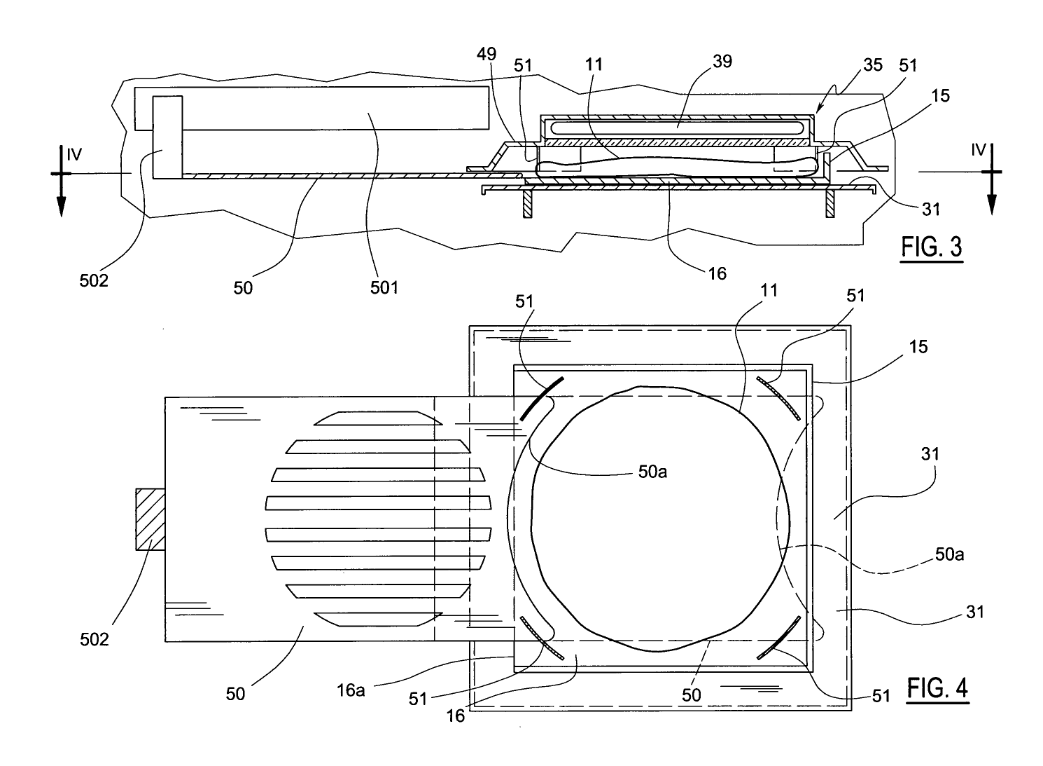

Subsequently the blade 50 separates the pizza 11 from the pack/tray 15, the pizza 11 being held in the heating position between the two reciprocally-facing heating devices, which at this point implement the heating phase. The blade 50 preferably affords numerous perforations (see FIG. 4) in order to enable the lower active surface 38 to transmit heat to the pizza 11 more effectively.

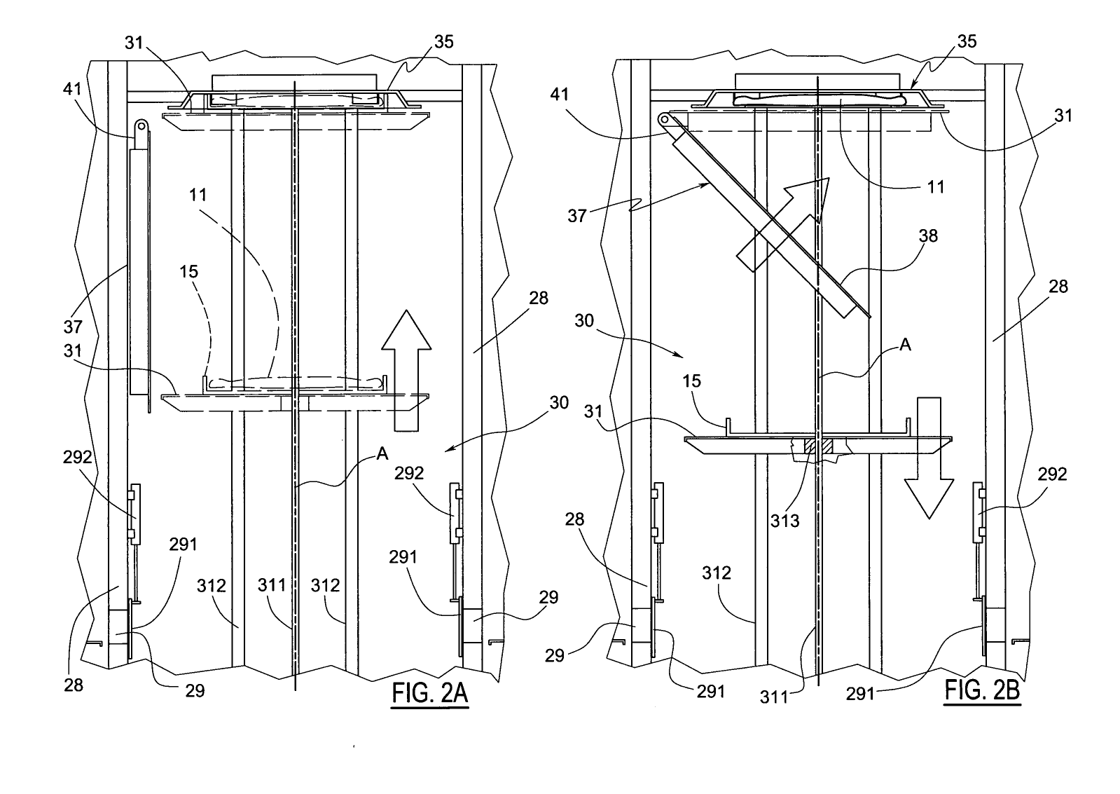

More in detail, in a preferred (but not exclusive) embodiment, this phase is implemented by vertically raising the support plate 31, after the support plate 31 has received the pack/tray 15 with the respective pizza 11 from the collection chamber 10, to an upper position, in which the pizza is situated in the heating position, that is, below and close to the active surface 36 of the upper heating device 35 (as shown by a continuous line in FIG. 2A and in FIG. 3).

During this shifting phase, the lower heating device 37 is situated to one side, in the idle position, adjacent to the side wall 28, in such a way as not to hinder the passage of the plate 31.

At this point, with the support plate 31 in the upper position, the blade 50 is moved horizontally in such a way as to insert itself between the lower surface of the pizza and the upper surface of the pack/tray 15 (as shown by the broken line in FIG. 4). The pizza is then retained in this (heating) position and the support plate 31 moves downwardly away from the pizza 11, taking the pack-tray 15 with it (see FIG. 3A), to a level lower than that in which the lower heating device 37 is situated in the idle position (as shown by a continuous line in FIG. 2B).

Subsequently the lower heating device 37 is rotated upwards by approximately 90° into an active position, in which its active surface 38 is placed below and close to the blade 50 supporting the pizza 11 in an upper position (as shown in FIGS. 2B and 3B).

Finally, a heating phase is implemented by supplying the two devices 35 and 37 with electricity at a voltage and for time period which are calibrated according to the heating characteristics desired for the pizza.

Following this stage, the lower heating device 37 is moved downwardly to the idle position and the plate 31 rises again to the upper position (see FIG. 5A), until it comes into contact, or into near contact, with the blade 50. The blade is then retracted horizontally, sliding out from under the pizza, until it clears the edge of the pizza 11 (as shown by the continuous line in FIG. 4), in such a way that the pizza 11 is resting only on the pack/tray 15. Next, the plate 31 is lowered again, bringing with it the pack/tray 15 together with the heated pizza 11, and is halted at the exit corridor defined by a pizza output mouth 45 which is situated at an intermediate height on the forward wall 301 of the second chamber 30 (as shown by a continuous line in FIG. 5B).

When the pizza is in this position, an expeller device 44 is activated, which horizontally pushes the pack/tray 15 with the relative heated pizza out of the chamber 30, and through the exit mouth 45, in such a way that the pizza on the pack/tray is delivered to the customer (as shown by a continuous line in FIG. 5B) waiting outside the distributor.

In a preferred (but not exclusive) embodiment shown in FIGS. 3 and 4, the upper heating device 35 exhibits a peripheral edge 49 surrounding the active surface 36 thereof and projecting laterally to form a bell-like shape, in such a way as to embrace the edge of the active surface 38 which is situated below it. Slender stop elements 51, which are attached to the lateral peripheral edge 49, project vertically and downwardly by an amount which exceeds a thickness of the food product, and surround the product in the heating position. In particular, the stop elements 51 are provided in the vicinity of the four corners of the base of the pack/tray 15.

The blade 50 has the form of a thin plate and exhibits a preferably rounded forward edge 50a, which slides between the upper surface of the base 16 of the pack/tray 15 and the lower surface of the pizza 11 which is resting on the base 16. The blade is mobile, on a fixed horizontal plane which is situated below the lower edge of the stops 51, between a retracted position (shown by a continuous line in FIG. 4) and an active position (shown by a broken line). When the blade is in the retracted position, and the pack/tray 15 which is situated on the plate 31 is brought into the upper position (as shown in FIG. 4), the forward edge 50a is, in plan view, at one side of, and at a short distance from the peripheral edge of the pizza 11, but above the forward edge 16a of the base 16 of the pack/tray 15. At the same time, the forward edge 50a of the blade is situated below the nearest stops 51.

In operation, when the plate 31 brings the pack/tray 15 and the pizza 11 to the upper position (FIGS. 3 and 4), the base 16 halts in contact (or nearly in contact) with the lower surface of the forward edge 50a of the blade, which in turn is substantially in contact with the extreme lower edge of the stops 51. Subsequently, while the pack/tray 15 and the pizza 11 are in these positions, the blade 50 is shifted forward. The forward edge 50a of the blade 50, already resting on the upper surface of the base 16, slides without hindrance or difficulty under the pizza 11, thus bringing the pizza 11 to rest upon the blade 50. This phase is also facilitated by the presence of the stops 51, which maintain the pizza in the heating position (in a centred position on the base 16), while the blade slides below it. The stops 51 perform the same action in reverse when the blade 50 returns to the retracted position after the heating phase and is slid out from under the pizza 11, the pizza 11 being released onto the base 16 of the pack/tray.

Several constructional details are illustrated herein below, which are schematically shown as possible embodiments in the figures:

the movement means of the pusher 27 comprise a support arm 271 which is guided by horizontal guides 272 which are arranged below the lower base 25 and are moved in a horizontal linear motion by a screw 273 activated by a motor 274 (see FIG. 2);

the support plate 31 is driven by a vertical screw 311 which vertically moves a nut screw 313 which is joined to the plate 31, the plate 31 being guided by vertical guides 312 which are arranged adjacently to the rear wall 302 of the chamber 30 (see FIGS. 2, 2A and 2B);

the two passage openings 29 which are afforded in the two side walls 28 of the chamber 30 are opened and closed by sliding doors 291, which are moved by actuators 292 (see FIG. 2);

the horizontal motion of the blade 50 is provided by a linear actuator 501 having a horizontal axis and arranged at the same level as, and behind the heating device 35, the linear actuator 501 driving a support 502, to which the rear edge of the blade 50 is attached (see FIG. 3);

the expeller device 44 comprises a crossbar 441, which comes into contact with the pack/tray 15, is guided at its two ends by means of guides 442 which adhere to the walls 28, and is made to move by a screw 443 with a nut screw, which is arranged adhering to a guide 442 (see FIGS. 2, 5A and 5B).

The described drive organs located in the chamber 30 are all organised in such a way as to define a free vertical corridor, allowing the plate 31 to slide from its lower position, which is coplanar with the opening 29, to the upper position (near the upper heating device 35) and alternatively for the rotation of the lower heating device 37 and the transverse motion of the expeller device 44.

Obviously numerous practical and applicational numerous modifications can be made to the invention without its thereby forsaking the inventive step as claimed herein below.

1. A method for movement and heating food product in an automatic distributor apparatus, the apparatus comprising:
at least a collection chamber (10) capable of containing a plurality of food products (11),
a second chamber (30),
a heater (35, 37) for heating the products (11), located in the second chamber (30), comprising a heating device (35), in a superior position, having an active heating surface (36) facing downwards, and a heating device (37), in a lower position, having an active heating surface (38),
the method comprising, for each food product (11):
(a) transferring the food products (11) individually from the collection chamber (10) to the second chamber (30);
(b) displacing the lower heating device (37) into an inactive position in which a nearing and distancing movement of the food product (11) with respect to the upper heating device (35) is enabled;
(c) vertically translating the food product, moving the food product only along a vertically-transferring axis (A), starting from entry thereof into the second chamber (30), up to a heating position, defined in proximity of and below the active heating surface (36) of the upper heating device (35);
(d) then bringing the lower heating device (37) into an active position in which the active surface (38) is facing upwards and is located below the active surface (36) of the upper heating device (35), the food product (11) being interposed, and
(e) the upper heating device (35) and the lower heating device (37) producing the heating of the food product (11),
(f) newly displacing the lower heating device (37) into the inactive position,
(g) vertically translating the food product (11) downwards along the vertical transferring axis (A) up to an expelling position outside the second chamber (30), the movements to which the product is subjected in the second chamber for its insertion between the upper heating device (36) and the lower heating device (37), being performed only by means of translation movements in a vertical axis.

2. The method of claim 1, further comprising:
arranging food products (11), which are placed on respective packs/trays (15) an upper surface of which is open, in the collection chamber (10);
transferring each food product (11), together with the respective pack/tray (15), from the collection chamber (10) to the second chamber (30);
separating the food product (11) from the pack/tray (15) by means of the blade (50), and during the heating phase retaining only the food product (11) in the heating position between the two heating devices (35, 37) which face one another;
bringing the heated food product (11) back to rest on the respective pack/tray (15);
dispensing the heated food product (11), resting on the respective pack/tray (15), externally of the distributor apparatus.

3. The method of claim 2, further comprising:
transferring the food products (11) arranged on the packs/trays (15) from the collection chamber (10) to the second chamber (30), one by one on a support plate (31);
raising the pack/tray (15) together with the respective food product (11) by means of the support plate (31) into an upper position in which the food product is arranged in a heating position;
moving the blade (50) horizontally while the support plate (31) is in the heating position, in order to insert the blade (50) between a lower surface of the food product (11) and an upper surface of the base of the pack/tray (15);
maintaining the food product (11) in the heating position and downwardly moving the support plate (31) together with the pack/tray only;
subsequently bringing the lower heating device (37) into an active position in which the active surface (38) thereof is arranged below and close to the blade (50) supporting the food product (11), which is situated in the upper position;
implementing a heating phase;
and finally, after heating the food product (11), moving the food product (11) downwardly again in order to dispense the food product (11) externally.

4. An automatic distributor apparatus of heated food products
comprising at least a collection chamber (10), the collection chamber (10) being capable of containing a plurality of food products (11) predisposed for a final heating, and
a second chamber (30) having heating means of the food products (11), means for transferring one food product (11) at a time from the collection chamber to the second chamber;
a heater for heating the food product (11), located in the second chamber (30), comprising a heating device (35) in a superior position, having a downwardly-facing active heating surface (36) and at least one heating device (37) in a lower position, having an active heating surface (38) facing upwards during a cooking stage;
a device (31) for vertically translating the food product (11), moving the food product (11) along a single vertical transfer axis (A), starting from entry thereof into the second chamber (30), up to a heating position, defined in proximity and below the active heating surface (36) of the upper heating device (35), and vertically translating the food product (11), moving the food product downwards along the vertical transfer axis (A), up to a delivery position outside the second chamber (30),
the lower heating device (37), during the translations, being activated to move between:
an active position in which the active surface (38) is facing upwards and is located below the active surface (36) of the upper heating device (35), the food product (11) being interposed between the two active surfaces (36, 38) in the heating position thereof; and
an inactive position, in which the device (27) does not obstruct the nearing and distancing of the food product (11) with respect to the upper heating device (35),
the movements to which the product is subjected in the second chamber for its insertion between the upper heating device (36) and the lower heating device (37), being performed only by means of translation movements in a vertical axis.

5. The apparatus of claim 4, wherein the food products are arranged in the collection chamber, resting on respective rigid or semi-rigid packs/trays (15) exhibiting an open upper surface, the apparatus further comprises a movement mechanism which separates the food product (11) from the pack/tray (15), retaining only the food product (11) between the two heating devices (35, 37) during the heating phase, and which then bring the heated food product (11) back to rest on the respective pack/tray (15).

6. The apparatus of claim 5, wherein the movement mechanism comprises:
a support plate (31) for the food products, which is arranged in the second chamber (30), and restingly receives a single food product (11) at a time, the food product (11) being arranged on a respective pack/tray (15);
a device for translating the support plate (31), the translatory motion raising the support plate (31) from a lower position, in which it receives a food product (11), which was transferred from the collection chamber (10), to an upper position, in which the food product (11) is in the heating position close to the active surface (36) of the upper heating device (35), and lowering the food product (11) into a position in which a device is located for dispensing the heated food product (11) externally;
a blade (50) being destined to support the food product (11) in the heating position, in proximity of and below the active surface (36) of the upper heating device (35),
a device for moving the blade (50), inserting the blade (50) between the upper surface of the base (16) of the pack/tray (15) and the food product (11) resting on the pack/tray (15), when the support plate (31) is in the upper position.

7. The apparatus of claim 6, further comprising stop elements (51) which are attached to the upper heating device (35) and project downwardly by more than a thickness of the food product (11), the stop elements (51) surrounding the product (11) which is situated in the heating position, thereby acting as a lateral stop for the product, in such a way that the product remains stationary as the blade (50) slides along a horizontal plane below the product (11).

8. The apparatus of claim 7, wherein the blade (50) is mobile on a fixed horizontal plane located below the lower edge of the stops (15) between a retracted position and an active position; when the blade is in a retracted position thereof, and the pack/tray (15) situated on the plate (31) is brought to the heating position, the forward edge (50a) being arranged, in plan view, to a side of, and at a short distance from the periphery of the pizza (11) and above the front edge (16a) of the base (16) of the pack/tray (15); at the same time, the forward edge (50a) of the blade is situated below the nearest stops (51).

9. The method of claim 1, wherein the food product is pizza.

10. The apparatus of claim 4, wherein the food product is pizza.
